(19) United States
(12) Patent Application Publication
(10) Pub. No.: US 2010/0214114 A1
(43) Pub. Date: Aug. 26, 2010

(54) BUS SYSTEM AND ASSOCIATED TRANSMISSION PROTOCOL

(75) Inventors: Oscar Marchetto, Oderzo (Treviso) (IT); Sergio Tomasella, San Polo Di Piave (Treviso) (IT); Alberto Andrioletti, Favaro Veneto (Venezia) (IT); Vincenzo Aprea, Portogruaro (Venezia) (IT)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: NICE SPA, Oderzo (treviso) (IT)

(21) Appl. No.: 12/525,762

(22) PCT Filed: Jan. 31, 2008
(86) PCT No.: PCT/IB2008/050340

§ 371 Date: Aug. 4, 2009

(30) Foreign Application Priority Data
Feb. 5, 2007 (IT) TV2007A000013

(51) Int. Cl. G05B 19/02; G06F 7/04

(52) U.S. Cl. 340/825.22; 340/5.7

(57) ABSTRACT

Bus system (10) used in actuating systems for moving gates, roller shutters or the like, in which the transmission of signals between a control unit (C, 18) and peripheral components (17, 19, 20, 21, 22, 24; Q) is performed using a transmission protocol.

The invention relates to a bus system and associated transmission protocol, used in systems for actuating gates, doors, main entrances, roller shutters or the like. The invention also relates to a method for transmitting signals on the bus.

By way of example reference shall be made below to actuating systems for gates of the leaf type (the actuating system for a sliding gate envisages only one motor).

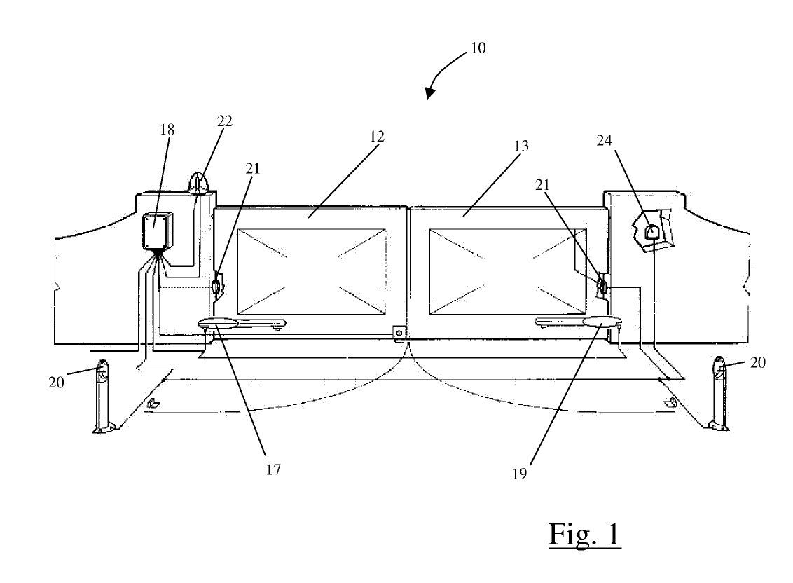

With reference to FIG. 1, a known actuating system 10 for a gate with two leaves 12, 13 comprises two motor units 17, 19, one for each leaf. A control unit 18 is fixed to the surrounding wall and is wired to all the other devices present in the actuating system, namely the pair of motor units 17, 19, two photocells 20 on a spacer post and two wall-mounted photocells 21, a flashing signalling lamp 22 and a wall-mounted operating device 24.

All these devices must be controlled by the control unit 18 and therefore—as can be seen in the “minimal” configuration shown in FIG. 1—the system must have a large number of electric lines (for conveying the power supply and digital signals) entering and leaving the said control unit 18. Precisely in the system according to FIG. 1 the following are necessary:

3 wires for the operating device 24,

2 wires for the flashing lamp 22,

5 wires for the photocells 20,

5 wires for the wall-mounted photocells 21,

2 wires for an electric lock (not shown) and

3 wires for the motor units 17, 19, giving a total of at least 20 wires leaving the control unit 18.

Owing to the safety regulations, the present systems envisage a greater number of accessory devices and the number of wires is destined to increase. In fact, the latest generation systems envisage 3 or 4 pairs of photocells, 1 flashing lamp, 2 or 3 control devices, 1 or 2 sensing edges as well as, obviously, 1 or 2 motors.

It must be emphasized that the elongated form of the motor is not determined merely by aesthetic considerations but also by structural requirements. The motor must have a length sufficient to contain a worm screw long enough to move the leaf through an arc of 110-120 degrees, and must have the least transverse volume since otherwise it would complicate installation on a wall or fence situated at right angles to the gate (in the closed position).

In other systems there is a smaller number of wiring leads since bus-type connection technology is used between the components of the system. Each device is connected to the control unit via only two wires and therefore the control unit 18 may have a smaller number of outgoing wires and precisely two wires for the motor units 17, 19, one wire for the flashing lamp 22, one wire for photocells 20 and one wire for a control device 24, resulting in a total of 8 wires. Each device, and therefore each pair of wires, has a corresponding connection terminal in the control unit 18.

Another example of this type can be found in the patent U.S. Pat. No. 7,091,687 which describes a two-wire bus system. The control unit has a set of terminals (two wires for each terminal) for connection of the peripheral devices. The bus uses the known “master and slave” technique where the master function is assigned to the control unit, while the slave function is assigned to all the peripheral devices. This operating logic envisages that any command and/or information is managed and sent by the control unit to a peripheral device which sends a response to the control unit whenever a command and/or information is received from the outside.

For the command and/or the information to be sent to a certain peripheral device, all the devices must have a well defined “encoded address”.

In the latest generation systems, where the safety regulations stipulate the use of several active and passive safety devices (various pairs of photocells, flashing lamps, multiple sensing edges, etc.), the flow of data on the bus is considerable and is mainly due to the fact that each command or information data sent by the control unit must have a corresponding response message from the peripheral device concerned. Consequently the interaction between the control unit and the peripheral devices may be slow and/or not optimum for ensuring the required level of safety, in particular in systems with a large number of peripheral devices.

In the abovementioned systems (FIG. 1) the motor units 17, 19 are pivotably mounted on the surrounding wall by means of suitable brackets and move together with the leaves 12, 13. The type of wire which connects the motor units 17, 19 to the control unit 18 must withstand the particular operating conditions, i.e. repeated bending with each movement and varying weather conditions (sun, cold, ice, etc.).

The simple insertion of the control unit 18 inside the motor units 17, 19 would result in a considerable increase in the longitudinal and transverse dimension of the said motor. In addition to the structural difficulties involved in housing it (resulting in a substantial increase in costs) and a significant deterioration in the aesthetic appearance, both due principally to the number of wires entering/leaving the motor units 17, 19 and their possible large size, it must be remembered that the motor could no longer be installed on walls or fences which are situated at right angles to the gate (in the closed position). The bundle of 8 to 20 pairs of wires, which must be flexible enough to bend during the movement of the leaves 12, 13 and which must withstand atmospheric agents over time, increase the complexity and the cost of the system. It is also necessary to mention the difficulty of installing the cables for such a large number of wires leaving the motor unit, with a probable increase in the risk of errors.

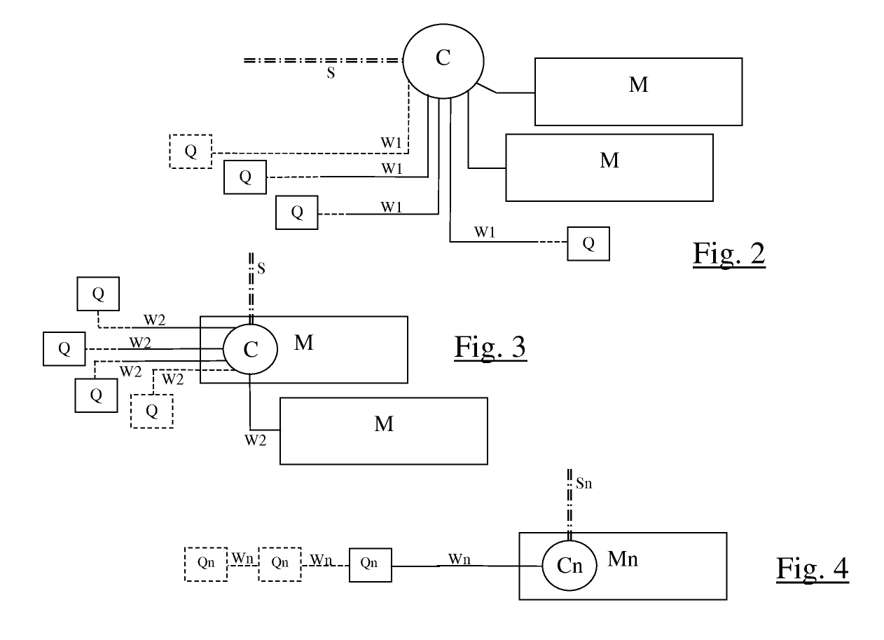

The two systems described are visible in orderly way in FIGS. 2 and 3. A control unit C is powered by a line S and wired with (several) cables W1 or W2 to components Q of the system, two of which are the motor units M. The complexity of the wiring layout is evident, whether one uses a bus-type connection or not, and in particular remembering that the connections W1 on average have three wires and the connections W2 have two wires.

The object of the invention is to provide a bus system and associated transmission protocol which limits the wiring needed for the system and improves the response time thereof.

This object is achieved with a bus system used in actuating systems for moving gates, roller shutters or the like in which the transmission of signals between a control unit and peripheral components is performed according to a transmission protocol, characterized in that each peripheral component is adapted only to transmit (using suitable transmission means) its own signal to the control unit solely within a time window situated in a predetermined position with respect to a period for scanning the status of the peripheral components of the system.

In order to simplify the system, advantageously each time window has an invariable duration, although it is possible to envisage for instance sending particular signals on the bus, following which a peripheral component requests, or is obliged by the control unit, to perform transmission within a time window having a duration which is modified or variable over time.

In order to simplify the system advantageously each time window is univocally associated with a given peripheral component, namely each component may operate, i.e. transmit, only in that specific window.

In order to ensure optimum timing, the control unit may comprise a transmitter stage able to transmit on the bus a synchronizing signal, the period of which defines the period for scanning the status of the peripheral components of the system. “Scanning period” is understood as referring to the cyclic period within which the control unit has polled or verified all the components of the system. The control unit comprises receiver processing means for receiving and processing the signal of a peripheral component solely within the time window pre-assigned to it.

The transmitter stage of the control unit may transmit periodically on the bus the synchronizing signal. This signal may be used by the peripheral components to determine the time window inside which they must be activated, for example calculating a constant delay with respect to the synchronizing signal, in such a way as to be in an invariable temporal position between two successive synchronizing signals.

Consequently it is advantageously possible to ensure that each time window is in an invariable position within two successive synchronizing signals. Nevertheless it is also possible to perform a cyclical permutation of the intervals so that on average each component is not always the last one to perform transmission.

Preferably, in order to establish an order for access to the bus, the same type of peripheral component is associated univocally with a given time window.

In fact, the safety devices such as photocells or sensing edges must always in any case transmit a signal on the bus since otherwise (if there is no signal) the control unit interprets the absence of signal as being an emergency situation. Therefore, to each pair of photocells a time window of their own is preferably assigned. Differently, the control devices (transponder cards, digital keypads, key-operated selectors, etc.) have associated with them a single and unique time window which can be exploited if necessary by one of them. Even in the case where several devices are present, the simultaneous activation of several devices of this type is highly unlikely. Incidental collisions on the bus may be tolerated.

Such an organization ensures rationalized assignment of the time windows to each peripheral component and a reduction in the duration of the working period between two synchronizing signals, namely a faster system is achieved.

The transmission protocol is therefore based on the method according to the invention for transmitting signals between a control unit and peripheral components on a bus used in actuating systems for moving gates, rollers shutters or the like, characterized in that each peripheral component is assigned a predefined time window within which only said component is allowed to transmit its own signal to the control unit. Preferably the predefined time window has an invariable duration.

The above considerations regarding the time windows and the management of the bus may be clearly understood as being also variants and/or embodiments of the method according to the invention.

Preferably the bus envisages the use of only two wires without a given polarity, and each device connected to it comprises a polarity adaptor.

The advantages of the invention will emerge more clearly from the following description of a preferred embodiment, illustrated in the accompanying drawings in which:

FIG. 1 shows a known actuating system;

FIGS. 2 and 3 shows block diagrams of known actuating systems;

FIG. 4 shows a block diagram of an actuating system resulting from adoption of the invention;

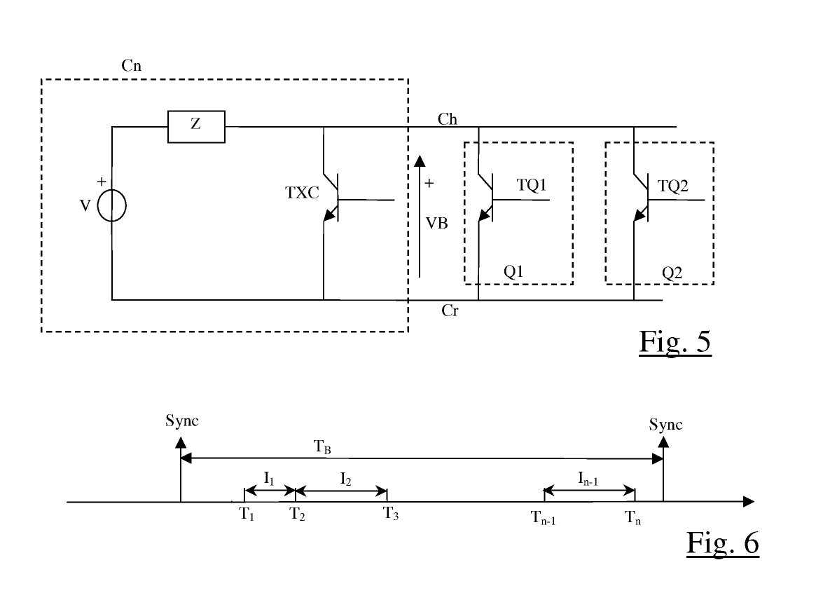

FIG. 5 shows a functional diagram of the bus according to the invention;

FIG. 6 shows a time diagram of the signals present on the bus according to FIG. 5;

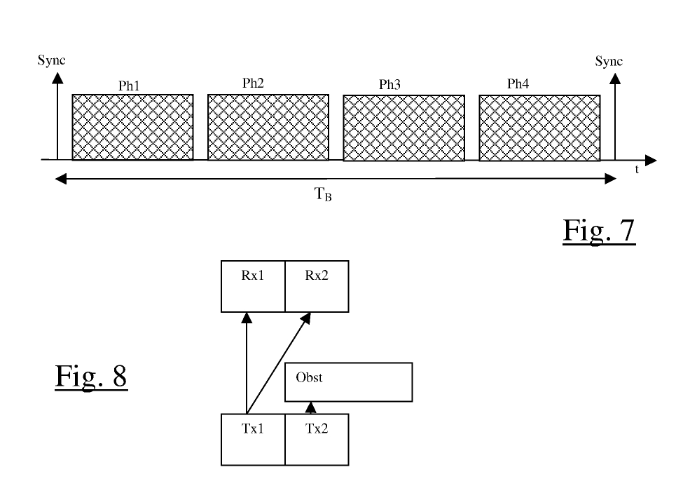

FIG. 7 shows a time diagram of the signals present on the bus according to FIG. 5;

FIG. 8 shows a diagram of two pairs of photocells.

The wiring of a system and a bus according to the invention are shown schematically in FIG. 4. A control unit Cn according to the invention is situated preferably inside the motor unit Mn and is powered by a line Sn (230 V or 24 V). The control unit Cn is wired with a single bifilar cable Wn to the components Qn, according to the invention, of the system, which are functionally the same as in FIGS. 2 and 3. The control unit Cn could likewise also be situated in any one of the components Qn.

The wire Wn reaches a component Qn and from here passes to the next one. The simplification of the overall wiring is obvious and represents a major advantage of the invention.

FIG. 5 shows a schematic illustration of the bus according to the invention. The control unit Cn, which is shown inside broken lines, is connected by means of two wires Ch, Cr to various components of the system, only two of which are shown and indicated within the broken lines by Q1, Q2. The wires Ch, Cr form the system bus and lead, inside or outside the control unit Cn, to a power supply voltage generator V which is formed with known circuit designs, and the associated output impedance Z. In parallel with each other and in shunt configuration between the wires Ch, Cr, downstream of the impedance Z, there are switching and transmission circuits/stages TXC, TQ1, TQ2, which are associated respectively with the control unit Cn and the two components Q1, Q2. The stages TXC, TQ1, TQ2 are chosen from any type and/or circuit component which is able to vary, upon command, its conductivity, in theory between zero and infinity, and shunt current between the wires Ch, Cr so as to produce a drop in voltage between them (bus voltage VB) downstream of the impedance Z. Each signal on the bus is transmitted generating voltage pulses of short duration and with suitable encoding, by means of switching of the stages TXC, TQ1, TQ2. Each variation in the voltage VB is detected by receiver stages (not shown) which are present in each component connected to the bus.

The brief duration of the signals, namely the temporary short-circuiting of the bus, may allow simultaneously the power supply to be transmitted to the components Q1, Q2 which have rectifier and filtering means for obtaining from the maximum value of the voltage VB a stabilized voltage. Advantageously a component Qn may comprise rectifier means adapted to make it indifferent to the polarity of the signals on the bus.

In order to control in an orderly manner transmission on the bus, the control unit Cn sends a synchronizing signal Sync via the stage TXC, at a periodic interval for example of 32 ms. The synchronizing signal Sync is transmitted in a normal operating mode (Normal Mode). Upon receiving the signal Sync the various components Q1, Q2 Qn connected to the bus respond with a digital signal. The information sent varies depending on whether they consist of:

safety devices, such as photocells and sensing edges, which respond always in order to signal their presence and their state;

control devices, such as keypads or actuating photocells (interruption of the beam triggers an action in the system), which respond only if they have to trigger execution of a given procedure in the control unit Cn.

Each device Qn, depending on its characteristics, has a reserved response time window after the signal Sync, so as to avoid possible overlapping. The time division for access to the bus by the various devices is shown in FIG. 6.

The time interval T_{B} between two signals Sync, which for the sake of simplicity may be kept constant, defines the scanning period in which the control unit Cn checks/controls/commands the status of the components in the system.

Tᵢ denotes an i-th instant between two signal Sync, while Iᵢ denotes the i-th time window within which a device Qn must respond/transmit so as to be correctly identified by the control unit Cn. The positions of the instants Tᵢ are advantageously (but not necessarily) predefined and invariable, and the duration of the windows Iᵢ depends on the functional characteristics of the i-th device Qn, which has the possibility of responding after each synchronizing signal Sync because it has a dedicated time interval Iᵢ, while in known bus systems each device Q is polled individually (by means of a respective address).

In a window Iᵢ, therefore, only one device Qn transmits, occupying the bus. Moreover, in respect of the above, the control unit Cn is able, by known means:

to transmit on the bifilar line a synchronizing signal Sync;

to receive after the synchronizing signal Sync a response signal from each device Qn only in a reserved time window Iᵢ having a predefined position with respect to said synchronizing signal Sync.

A communications network is established such as to use therefore only one bifilar cable (advantageously without imposed polarity) to which the different peripheral devices (operating or control devices) may be connected.

This network allows a high transmission speed for the data and/or commands and therefore guarantees the safety of the system since:

(i) a very fast response to dangerous events is obtained;

(ii) the time required for the response of the peripheral devices (typical of a master/slave system) are eliminated;

(iii) the time required for addressing the command and/or information and associated encoding/decoding times are eliminated.

Even increasing the number of peripheral devices installed, the total data transmission time is 50% less than that for buses of the known art; in known buses each transmission envisages a polling+response between master and slave (2 data), while in the bus according to the invention each transmission envisages only one response.

The signal Sync may in turn be encoded, by means of encoding means, such that the control unit is able to send information and/or data which are received by the peripheral devices.

The invention may also allow the two-way communication between components on the bus: a component can interpret the information which is sent on the bus depending on the temporal position of the communication interval Iᵢ since it may have a fixed position (in the known buses only the control unit interprets the information which it itself requested). The signal sent by any one of the peripheral devices is introduced into the bus network and is available to all the devices, as well as to the control unit. In this way, for example, a flashing lamp can start a “courtesy light” mode if it detects in the bus network a signal of “opening” sent to the control unit by a control device (key-operated selector, keypad).

Communication on the bus may advantageously also be performed in Low Power Mode. In this case the control unit Cn does not generate the synchronizing signal Sync, and its absence alerts all the devices that they may enter in a low power condition (Sleep Mode). This decision is reached owing to processing means in the control unit Cn, which are able to interrupt the transmission of the synchronizing signal (Sync) and enter into Low Power Mode.

The components are reactivated into Normal Mode when the control unit decides autonomously to re-introduce onto the bus the signal Sync or when a control device (keypad or actuating photocell) transmits a signal on the bus. The control unit Cn detects this signal and reverts to Normal Mode. For this purpose, the peripheral components Qn comprise processing means which are able to select a low power operating mode when no synchronizing signal is emitted by the control unit Cn.

The switch-over to Low Power Mode occurs as a result of an autonomous decision of the control unit Cn which, when the gate is in the closed condition, allows a reduction in the power consumption of the system.

The Low Power Mode is particularly useful in the case of battery or photovoltaic panel powered systems.

The signal Sync may also be used in additional Modes.

In the case already considered, T_{B} is divided into as many time windows as there are peripheral devices Qn (apart from possible minor temporal deviations between one window and the next, necessary for correct management of the timing).

At the same time, the photocells, which receive the signal Sync from the bus and process it using processing means, divide internally the period T_{B} further into as many time windows as there are pairs of photocells, and each receiver Rx and transmitter Tx of each pair is automatically assigned a precise time window inside which it may operate.

An example of four pairs of photocells can be seen in FIG. 7. The time interval T_{B} is divided into 4 time windows Ph1, Ph2, Ph3, Ph4 within which the photocells are activated alternately, i.e. the phototransmitter Tx1 and the receiver Rx1 of the first photocell are activated only in the window Ph1, while the phototransmitter Tx2 and the receiver Rx2 of the second photocell are activated only in the window Ph2 and so on. The phototransmitter Tx1 sends the infrared beam and the corresponding receiver Rx1 receives and analyses the corresponding signal thereof via the processing means; the same applies to Tx2 and Rx2.

In this way the photocells are immune from mutual interference: if they were all always active, a receiver could receive the beam (see arrows in Figure) from the transmitter of another pair (see FIG. 8 showing the case where there are two pairs). The receiver Rx2 could receive the beam of Tx1 and signal that there is no obstacle Obst present. Since, instead, Rx1 and Tx1 are activated at different times from Rx2 and Tx2, when Rx2 analyses the beam received it detects the obstacle Obst because Tx1 is switched off and the obstacle is blocking the beam of Tx2.

The receiver photocell Rx, after receiving the signal from the corresponding transmitter photocell Tx, sends a signal to the control unit by means of the bus during its own time window from among those Iᵢ assigned on the bus.

It has therefore been shown that the invention is able to simplify wiring and installation of the system and therefore reduce costs. The costs for production of the motor unit and the system installation times are reduced compared to a considerable increase in the performance of the system.

1-22. (canceled)

23. A bus system for use in transmission of signals with respect to an actuating system comprising
a control unit; and
a plurality of peripheral components electrically connected to the control unit via a bus, wherein transmission of signals between the control unit and the peripheral components is configured via use of a transmission protocol, each of the peripheral components configured to transmit only its own signal to the control unit solely within a time window, each time window of the peripheral components situated in a predetermined position with respect to a period for scanning status of the peripheral components.

24. The bus system of claim 23 wherein each time window of the peripheral components has an invariable duration.

25. The bus system of claim 23 wherein each time window of the peripheral components is associated univocally with one of the peripheral components.

26. The bus system of claim 23 wherein the control unit comprises a transmitter stage for transmittance of a synchronizing signal on the bus, wherein the synchronizing signal has a signal period that defines the period for scanning status of the peripheral components.

27. The bus system of claim 26 wherein the transmitter stage is adapted to periodically transmit the synchronizing signal from the control unit on the bus.

28. The bus system of claim 26 wherein each time window of the peripheral components has a constant delay with respect to the synchronizing signal so as to be in a temporal position that is invariable between two successive synchronizing signals.

29. The bus system of claim 26 wherein the control unit is configured to interrupt transmission of the synchronizing signal and assume a low-power operating mode, wherein the peripheral components are configured to interpret absence of the synchronizing signal as a command to enter into the low-power operating mode.

30. The bus system of claim 23 wherein the bus consists of a bifilar line.

31. The bus system of claim 23 wherein the bus system is for use in an actuating system for one of a moving gate and a roller shutter.

32. A control unit for the bus system according to claim 23 comprising receiver processing means for receiving and processing the signals of the peripheral components solely within their respective time windows.

33. The control unit of claim 32 further comprising a transmitter stage for transmittance of a synchronizing signal on the bus, wherein the synchronizing signal has a signal period that defines the period for scanning status of the peripheral components.

34. The control unit of claim 33 further comprising processing means configured to interrupt transmission of the synchronizing signal and assume a low-power operating mode wherein the control unit is configured to interrupt transmission of the synchronizing signal and assume a low-power operating mode

35. The control unit of claim 33 further comprising encoding means for encoding data in the synchronizing signal to be transmitted to the peripheral components.

36. A first peripheral component for the system according to 23 comprising transmission means adapted to transmit a signal to the control unit solely within a time window of the first peripheral component, the time window of the first peripheral component situated in a predetermined position with respect to the period for scanning status of the peripheral components of the system.

37. The first peripheral component of claim 36 further comprising detection means for detecting a synchronizing signal of the control unit and establishing the predetermined position of its own transmission time window.

38. The first peripheral component of claim 36 further comprising processing means adapted to select a low-power operating mode when no synchronizing signal is emitted by the control unit.

39. The first peripheral component of claim 36 wherein the detection means is further adapted to interpret and process information transmitted on the bus by other of the peripheral components of the system during their transmission time windows.

40. The first peripheral component of claim 36 further comprising rectifier means adapted to make the first peripheral component indifferent to polarity of signals on the bus.

41. The first peripheral component of claim 36 further comprising rectifier and filtering means for obtaining a power supply voltage from a maximum voltage value on the bus.

42. The first peripheral component of claim 36 wherein the component comprises a photocell.

43. The first peripheral component of claim 42 wherein the detection means is further adapted to obtain from a period of a synchronizing signal transmitted by the control unit a time window only in which respective emitter and radiation sensor are active, the time window not coinciding with each time window of other of the peripheral components, the other of the peripheral components comprising photocells.

44. A method for transmitting signals between a control unit and peripheral components on a bus used in actuating systems, the method comprising the step of:
assigning to each peripheral component a predefined time window inside which only said peripheral component is allowed to transmit its signal to the control unit.

45. The method of claim 44 wherein the predefined time window has an invariable duration.

46. The method of claim 44 wherein the bus system is for use in an actuating system for one of a moving gate and a roller shutter.
